(19) United States
(12) Patent Application Publication
(10) Pub. No.: US 2023/0296501 A1
(43) Pub. Date: Sep. 21, 2023

(54) ANALYSIS DEVICE, ANALYSIS METHOD, PROGRAM FOR ANALYSIS DEVICE, LEARNING DEVICE FOR ANALYSIS, LEARNING METHOD FOR ANALYSIS, AND PROGRAM FOR LEARNING DEVICE FOR ANALYSIS

(71) Applicant: HORIBA, LTD., Kyoto-shi, Kyoto (JP)

(72) Inventors: Hirotaka YABUSHITA, Kyoto-shi, Kyoto (JP); Makoto NAGAOKA, Kyoto-shi, Kyoto (JP)

(73) Assignee: HORIBA, LTD., Kyoto-shi, Kyoto (JP)

(21) Appl. No.: 17/928,791

(22) PCT Filed: May 10, 2021
(86) PCT No.: PCT/JP2021/017666

§ 371 Date: Jun. 8, 2023

(30) Foreign Application Priority Data
Jul. 13, 2020 (JP) 2020-120230
Sep. 10, 2020 (JP) 2020-151801

(51) Int. Cl. G01N 21/35; G06N 20/00

(52) U.S. Cl. CPC G01N 21/35; G06N 20/00; G01N 2021/3595; G01N 2201/12753

(57) ABSTRACT

An analysis device analyzes a measurement sample based on spectral data obtained from that measurement sample. This analysis device includes a correlation data storage portion that stores correlation data that shows a correlation between spectral data for a reference sample in which total analysis values for a predetermined plurality of components are already known, and a total analysis value of the reference sample, and a calculation main unit that applies the correlation data stored in the correlation data storage portion to the spectral data obtained from the measurement sample, and then calculates the total analysis values of the predetermined plurality of components contained in the measurement sample. The reference sample includes a first reference sample that contains the predetermined plurality of components, and a second reference sample that is consisting of either one or a plurality of the components contained in the first reference sample.

### TECHNICAL FIELD

The present invention relates to an analysis device that analyzes a measurement sample based on spectral data obtained from that measurement sample.

### TECHNICAL BACKGROUND

Conventionally, spectroscopic analyzers such as FID analyzers and FTIR analyzers and the like are used to measure concentrations and quantities of total hydrocarbons (hereinafter, these may be referred to as THC) contained, for example, in automobile exhaust gas and the like.

FID analyzers have excellent analysis accuracy, however, because they need to be supplied with hydrogen gas (H2) as an auxiliary gas and with helium (He) as a carrier gas, they are also problematic in that they are difficult to handle and expensive to run.

In contrast, FTIR analyzers have advantages in that they are easier to handle and inexpensive to run, however, they are also problematic in that they have poor analysis accuracy. In other words, in FTIR analyzers a two-stage computation is performed. Namely, firstly, the concentrations of the respective hydrocarbons (HC) are individually determined from the optical spectrum, and weightings are then attached to each of these so as to provide a sum total. However, because errors that may occur in the settings of the weighting coefficient become superimposed on any errors that may occur in the concentration measurements of each HC, it is difficult for this measurement accuracy to be improved.

In order to improve the measurement accuracy of an FTIR analyzer, there is described in Patent Document 1 an FTIR analyzer that employs machine learning to calculate a correlation between an optical spectrum obtained by irradiating light onto a reference sample and the THC concentration, and then applies the optical spectrum of a measurement sample to a mechanical learning model that shows this calculated correlation so as to enable the THC concentration to be estimated. In Patent Document 1, a method in which a gas (for example, automobile exhaust gas or the like) that contains a plurality of types of hydrocarbons of the same types as those in the measurement sample is used as the reference sample is described.

### DOCUMENTS OF THE PRIOR ART

### Patent Documents

[Patent Document 1] WO No. 2019-031331

### DISCLOSURE OF THE INVENTION

### Problems to be Solved by the Invention

However, because a large number of hydrocarbons having a high level of mutual correlation with each other are mixed together in exhaust gas, as is described in the aforementioned Patent Document 1, in a case in which mechanical learning is performed using only the optical spectrum of the exhaust gas as the training data, the problem arises that it is difficult to separate out and learn the contributions of each hydrocarbon in the THC concentration. For this reason, if, for example, the composition of the hydrocarbons in the measurement sample deviates from the hydrocarbon components contained in the learned data, then the problem of so-called ‘overfitting’ occurs in which it is difficult for a sufficient level of analysis accuracy to be obtained.

The present invention was conceived in view of the above-described circumstances, and it is a principal object thereof to enable measurement accuracy to be improved in an analysis device such as an FTIR spectrometer and the like that estimates total analysis values of a predetermined plurality of components such as THC from the spectral data of a measurement sample.

Namely, an analysis device according to the present invention is a device that analyzes a measurement sample based on spectral data obtained from that measurement sample, and that includes a correlation data storage portion that stores correlation data that shows a correlation between spectral data for a reference sample in which total analysis values for a predetermined plurality of components are already known, and a total analysis value of the reference sample, and a calculation main unit that applies the correlation data stored in the correlation data storage portion to the spectral data obtained from the measurement sample, and then calculates the total analysis values of the predetermined plurality of components contained in the measurement sample, wherein the reference sample includes a first reference sample that contains the predetermined plurality of components, and a second reference sample that is consisting of either one or a plurality of the components contained in the first reference sample, and wherein the correlation data is date showing a machine learning model that employs machine learning to calculate as the training data first reference sample data that includes spectral data for the first reference sample and a total analysis value for the first reference sample, and second reference sample data that includes spectral data for the second reference sample and a total analysis value for the second reference sample.

Note that this spectral data may be spectral data for light that has been transmitted through a measurement sample (or through a reference sample) and has subsequently been reflected or scattered. Additionally, the spectral data may be spectral data of light that has been absorbed by the measurement sample (or the reference sample) (i.e., light absorption spectral data), or corrected light absorption spectral data in which the effects from interference components contained in the measurement sample (or the reference sample) have been reduced or removed. The spectral data may also be mass spectral data obtained by ionizing the measurement sample (or the reference sample).

Moreover, the total analysis value is a total value of physical quantities of a plurality of various components, and may be a total value of the concentrations or a total value of the masses or the like of a plurality of components.

If this type of structure is employed, then because the machine learning model used to calculate the total analysis values performs machine learning using as training data not only measurement data for the first reference sample containing a plurality of components (for example, for exhaust gas or the like containing a plurality of hydrocarbons), but also using measurement data for the second reference sample which is consisting of either one or a plurality of the components contained in the first reference sample (for example, hydrocarbons), a greater level of accuracy is achieved compared, for example, to when the extent of the contribution and the like of each component to the total analysis value of the plurality of components is learned. By using a machine learning model in which the accuracy has been improved in this way, and in which the robustness of the learning model against changes in the structural components of the measurement sample is improved, it becomes possible to improve the analysis accuracy of an analysis device that estimates the total analysis values of predetermined components from spectral data of the measurement sample. Note that the second reference sample may contain at least components that are contained in the first reference sample, or may contain components other than the components contained in the first reference sample.

As the second reference sample, it is preferable that a reference sample consisting of either one or a plurality of the components that make up the predetermined plurality of components be used.

If this type of structure is employed, then by individually learning the contributions of each component (for example, hydrocarbons) to the total analysis value (for example, the THC concentration), it becomes possible to avoid overfitting a machine learning model, and to thereby further improve the analysis accuracy of the analysis device.

In addition, as the second reference sample, it is preferable that a reference sample consisting of either one or a plurality of the components for which the total analysis value is zero be used. In this case, it is preferable that the components making up the second reference sample be components that are contained in the measurement sample.

By employing this type of structure, it is possible to learn the spectrum of components that do not contribute to the total analysis value of the predetermined plurality of components, and in a case in which components of this type are contained in the measurement sample, then it is possible to prevent these components from being erroneously added to the total analysis value of the predetermined plurality of components.

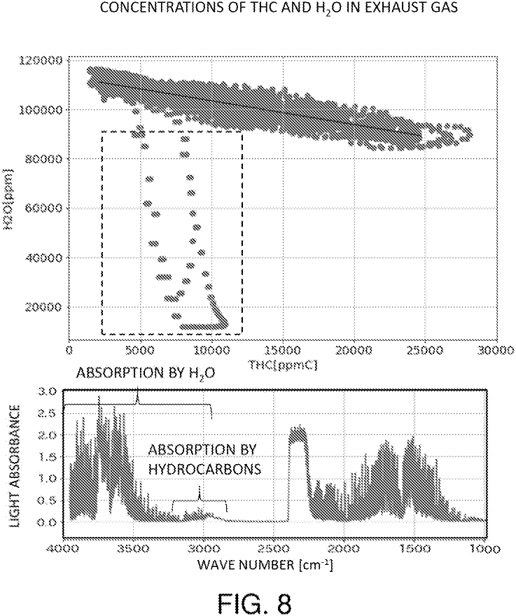

In a case in which the measurement sample is exhaust gas, for example, as is shown in FIG. 8, it would appear at first glance that a linear relationship exists between the THC concentration and the H₂O concentration in the exhaust gas, however, the nature of this relationship changes depending on the driving conditions (as in the region indicated by the broken line). In other words, it may be said that a pseudo relationship exists between the THC concentration and the H₂O concentration in the exhaust gas. If learning is performed using this type of measurement data, the data in the broken line region which has a low appearance frequency is not regarded as important, and a learning model in which a wave number expressing the absorption by H₂O is used to estimate the THC is created, so that the analysis accuracy in the broken line region deteriorates.

Because of this, as the second reference sample, it is preferable that a reference sample consisting of either one or a plurality of the components for which a pseudo-correlation exists between itself and the total analysis value be used.

By employing this type of structure, by causing the learning to recognize that components having a pseudo relationship with the total analysis values of the predetermined plurality of components do not contribute to the total analysis values, it is possible to avoid learning pseudo relationships such as that described above, and to thereby further improve the analysis accuracy of the analysis device.

Moreover, in, for example, an automobile or the like, when the engine is misfiring or in extremely low temperatures or the like, the fuel combustion becomes extremely poor, and a large quantity of non-combusted fuel vapor is contained in the exhaust gas so that heavier hydrocarbon components are contained therein compared to normal exhaust gas components. Because of this, it is preferable that a fuel that generates the exhaust gas be used as the second reference sample.

If this type of structure is employed, then by learning the spectrum of the fuel it becomes possible to perform analysis with a high degree of accuracy in broad range of conditions including phenomena such as the engine misfiring or in extremely low temperatures.

In order to use a machine learning model that has a higher level of accuracy and is more robust against changes in the structural components of a measurement sample, it is preferable that the second reference sample be consisting of components that are included in the first reference sample.

Furthermore, in the above-described analysis device, it is also preferable that a plurality of correlation data calculated for each one of various types of fuel be stored in the correlation data storage portion, and that the calculation main unit switch the correlation data that is to be applied to the spectral data obtained from the measurement sample in accordance with the type of fuel used to generate the measurement sample.

If this type of structure is employed, then it is possible to further improve the analysis accuracy by employing mutually different correlation data that have been calculated in accordance with each of the respective types of combustion.

An example of a specific aspect that enables the effects of the present invention to be demonstrated particularly clearly is an aspect in which the measurement sample or the first reference sample is exhaust gas from an automobile, and hydrocarbons (HC) form the component that is to be the subject of analysis. Moreover, the THC concentration is an example of the total analysis value of a predetermined plurality of components.

Furthermore, this analysis device is preferably an FTIR type of device, and it is also preferable that, in a case in which the THC are being analyzed, the total analysis value of the reference sample be measured using an FID analyzer.

A learning device for analysis that specializes in a function of calculating just a correlation by using only a reference sample is also one of the inventions of the present application.

In this case, it is preferable that this learning device for analysis includes a receiving portion that receives spectral data obtained from a reference sample in which total analysis values for a predetermined plurality of components are already known, a reference sample data storage portion that stores reference sample data that includes total analysis values for a plurality of the reference samples that are mutually different from each other, and a correlation calculating portion that, taking the reference sample data as training data, employs machine learning to calculate a common correlation between the spectral data of each reference sample and the total analysis values, wherein the reference sample includes a first reference sample that contains the predetermined plurality of components, and a second reference sample that is consisting of either one or a plurality of the components contained in the first reference sample, and wherein the reference sample data includes first reference sample data that contains spectral data for the first reference sample and a total analysis value for the predetermined plurality of components contained in the first reference sample, and second reference sample data that contains spectral data for the second reference sample and a total analysis value for the predetermined plurality of components contained in the second reference sample.

### Effects of the Invention

According to the present invention which is formed in the manner described above, it is possible to improve the measurement accuracy in an analysis device such as an FTIR spectroscopic analyzer and the like.

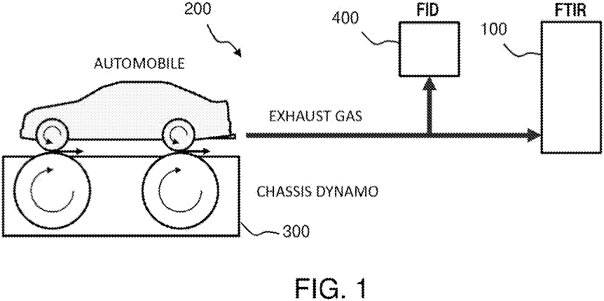

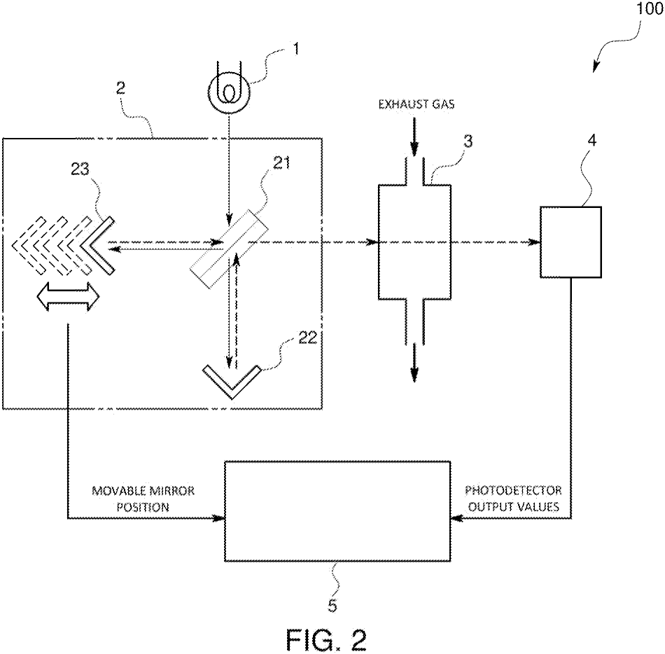

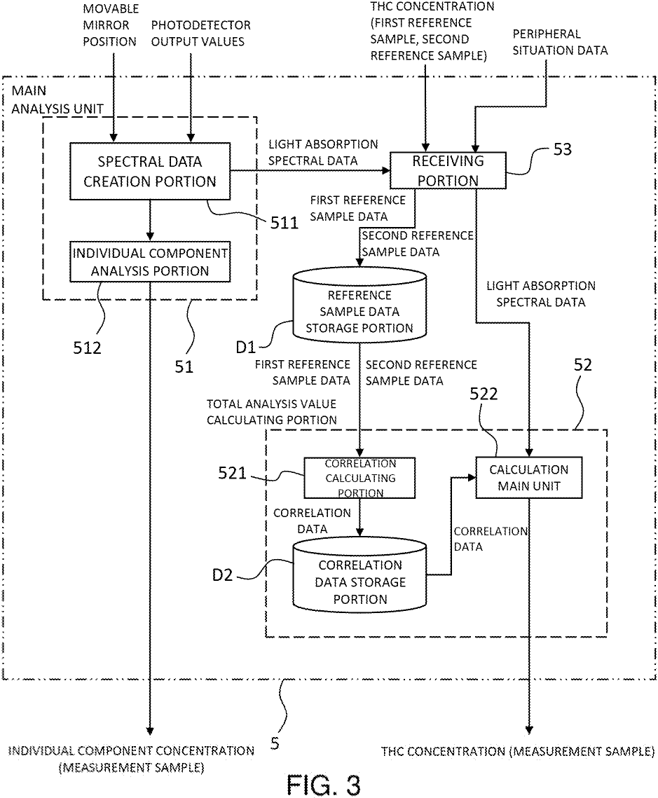

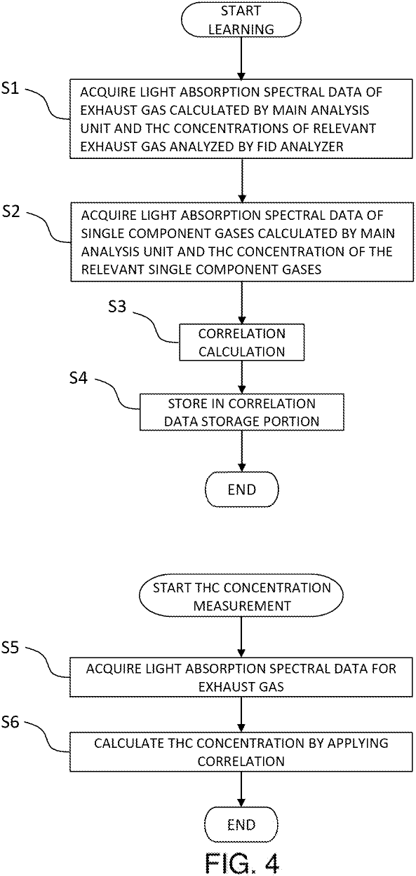

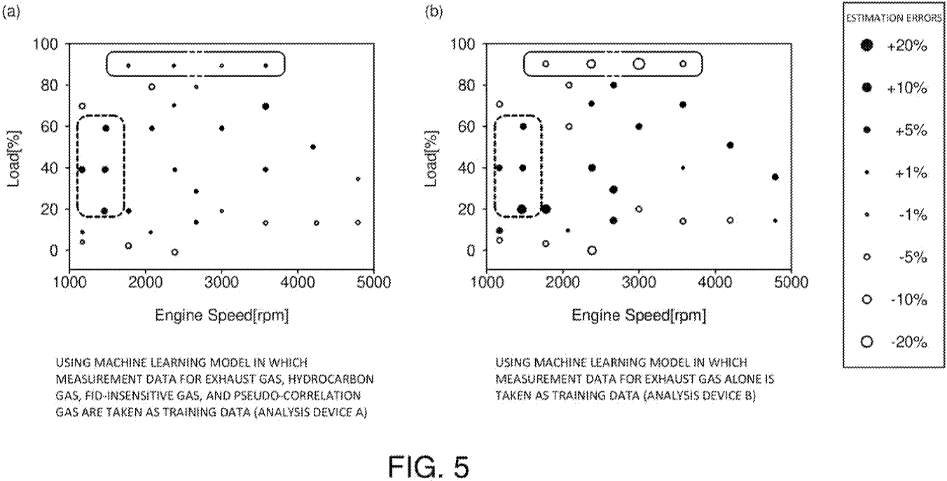

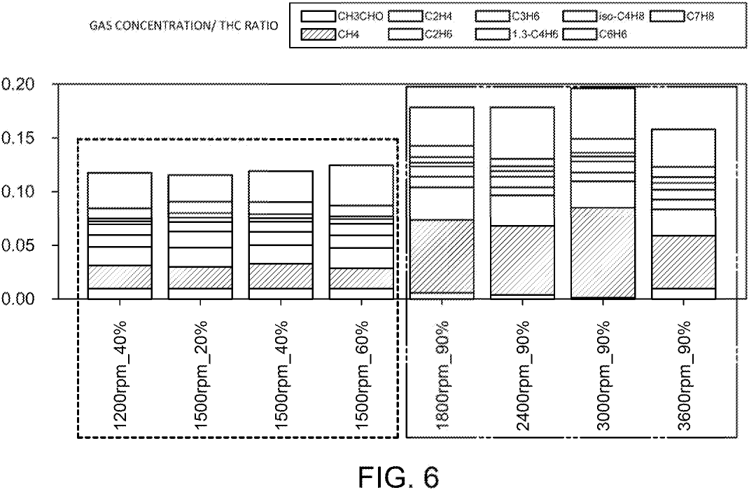

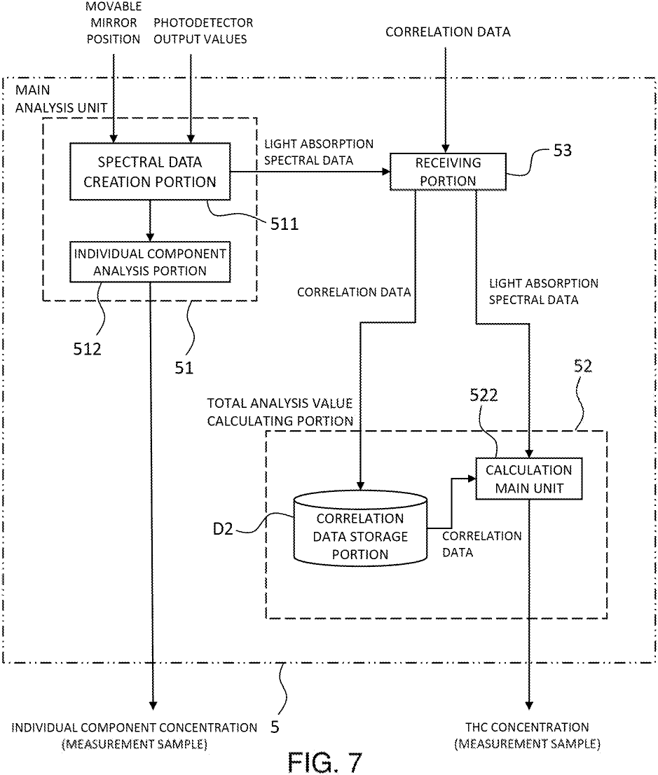

### BRIEF DESCRIPTION OF THE DRAWINGS

[FIG. 1] FIG. 1 is an overall view of an exhaust gas measurement system that includes an analysis device according to an embodiment of the present invention.

[FIG. 2] FIG. 2 is a schematic view showing an overall layout of the analysis device according to the same embodiment.

[FIG. 3] FIG. 3 is a function block diagram of an arithmetic processing device according to the same embodiment.

[FIG. 4] FIG. 4 is a flowchart showing an operation of the analysis device according to the same embodiment.

[FIG. 5] FIG. 5 is a graph showing experiment results obtained by using the analysis device according to the same embodiment.

[FIG. 6] FIG. 6 is a graph showing experiment results obtained by using the analysis device according to the same embodiment.

[FIG. 7] FIG. 7 is a function block diagram of an arithmetic processing device according to another embodiment.

[FIG. 8] FIG. 8 is a view illustrating a pseudo-correlation between THC and H₂O.

Description of the Reference Numerals
100 ... Analysis Device
51 ... Main analysis unit
52 ... Total Analysis Value Calculating Portion
521 ... Correlation Calculating Portion
522 ... Calculation Main Unit
53 ... Receiving Portion

### BEST EMBODIMENTS FOR IMPLEMENTING THE INVENTION

Hereinafter, an analysis device 100 according to an embodiment of the present invention will be described with reference to the drawings.

The analysis device 100 of the present embodiment forms part of an exhaust gas measurement system 200. As is shown in FIG. 1, this exhaust gas measurement system 200 is equipped with a chassis dynamo 300, an FID analyzer 400, and with the analysis device 100.

The analysis device 100 is a Fourier-Transform Infrared Spectrometer, which is commonly known as an FTIR, and is used to simultaneously calculate the concentrations and the like of either one or a plurality of components such as inorganic compounds, hydrocarbons, and nitrogen compounds and the like that are contained in a measurement subject. More specifically, as is shown in FIG. 2, this analysis device 100 (hereinafter, in order to distinguish it from other devices, the analysis device 100 may be referred to as the ‘FTIR analyzer 100) is equipped with a light source 1, an interferometer (i.e., a spectroscopic portion) 2, a sample cell 3, a photodetector 4, and an arithmetic processing device 5 and the like.

The light source 1 emits light having a broad spectrum (i.e., continuous light containing light of a large number of wave numbers) and, for example, a tungsten iodine lamp or a high luminance ceramic light source or the like may be used for the light source 1.

As is shown in the same drawing, what is known as a Michelson interferometer that is equipped with a single half mirror (i.e., a beam splitter) 21, a fixed mirror 22, and a movable mirror 23 is used for the interferometer 2. Light from the light source 1 that is irradiated onto this interferometer 2 is split into reflected light and transmitted light by the half mirror 21. One portion of the light is reflected by the fixed mirror 22, while another portion of the light is reflected by the movable mirror 23. The light portions then return to the half mirror 21 where they are synthesized together and then emitted from the interferometer 2.

The sample cell 3 is a transparent cell into which exhaust gas that is serving as the measurement sample is introduced. The light emitted from the interferometer 2 is transmitted through the measurement sample inside the sample cell 3, and is guided to the photodetector 4.

Here, the photodetector 4 is what is commonly known as an MCT photodetector 4.

The arithmetic processing device 5 is provided with analog electric circuitry that includes a buffer and an amplifier and the like, and digital electrical circuitry such as a CPU, memory, and a DSP and the like, and an A/D converter and the like that is interposed between these.

As a result of the CPU and the peripheral devices thereof operating in mutual collaboration in accordance with a predetermined program stored in the memory, as is shown in FIG. 3, the arithmetic processing device 5 is made to function as a main analysis unit 51 that, based on output values from the photodetector 4, calculates light transmission spectral data which shows the spectrum of the light transmitted through the sample, identifies various components contained in the measurement sample by calculating light absorption spectral data from the light transmission spectral data, and calculates the concentrations (or quantities) of each of these components.

This main analysis unit 51 is equipped with a spectral data creation portion 511, and an individual component analysis portion 512.

If the movable mirror 23 is moved backwards and forwards and, taking the position of the movable mirror 23 as a horizontal axis, the intensity of the light transmitted through the sample is observed, then in the case of a single wave number, the light intensity depicts a sine curve due to interference. On the other hand, because the actual light transmitted through the sample is continuous light so that the sine curve differs for each wave number, for the actual light intensity, the sine curves depicted by each wave number become mutually superimposed so that the interference pattern (i.e.. the interferogram) has a wave packet configuration.

The spectral data creation portion 511 determines the position of the movable mirror 23 using, for example, the range finder of a HeNe laser or the like (not shown in the drawings), and also determines the light intensity at each position of the movable mirror 23 using the photodetector 4. By then performing a fast Fourier transform (FFT) on the interference pattern subsequently obtained therefrom, this is converted into light transmission spectral data taking each wave number component as the horizontal axis. Next, based on light transmission spectral data that has been measured in advance, for example, when the interior of the sample cell was empty, the light transmission spectral data for the measurement sample is further converted into light absorption spectral data.

The individual component analysis portion 512 identifies the various components contained in the measurement sample, for example, from the respective peak positions (i.e., the wave number) and heights thereof in the light absorption spectral data, and then calculates the concentrations (or quantities) of the respective components.

In this way, the analysis device 100 of the present embodiment is used as an exhaust gas analysis device that measures the THC concentration (or quantity) in the exhaust gas that is serving as the measurement sample. In this embodiment, as is shown in FIG. 3, the arithmetic processing device 5 is further endowed with the functions of a receiving portion 53 and a total analysis value calculating portion 52 and the like in order to enable the THC concentration (or quantity) of the measurement sample to be measured even more accurately.

The receiving portion 53 receives the THC concentration of a gas (exhaust gas in this case) that contains a plurality of different types of hydrocarbons measured by the FID analyzer 400. This exhaust gas whose THC concentrations, having been measured by the FID analyzer 400, are consequently known is hereinafter referred to as a first reference sample.

This first reference sample 1 is introduced into this FTIR analyzer 100 as well as into the FID analyzer 400, and the light absorption spectral data thereof is acquired by the main analysis unit 51 as well. The receiving portion 53 then receives the light absorption spectral data for the first reference sample, which is interim information calculated by the main analysis unit 51, and this light absorption spectral data is linked to the THC concentration of the first reference sample that has been measured by the FID analyzer 400 so as to create first reference sample data. This first reference sample data is then stored in a reference sample data storage portion D1 that has been established in a predetermined area of the memory.

Here, in the analysis device 100 of the present embodiment, the receiving portion 53 is formed so as to receive the THC concentration not only of exhaust gas, but additionally of a plurality of single component gases. The THC concentrations of these single component gases are determined in advance, and each of these single component gases whose THC concentration is already known is referred to below as a second reference sample.

More specifically, the second reference sample is consisting of either one or a plurality of components that are contained in the first reference sample. Yet more specifically, the second reference sample may be:
(1) A hydrocarbon gas (referred to in the Claims as a component that forms a predetermined plurality of components) such as methane (CH₄), toluene (C₇H₃), and Octane (C₈H₁₈) and the like;
(2) An FID-insensitive gas that has no sensitivity towards FID analysis (referred to in the Claims as a component for which a total analysis value of the predetermined plurality of components is zero) such as a gas (such as formaldehyde and formic acid and the like) that contains carbonyl carbon (i.e.. carbon having a C = 0 double bond) and the like; and
(3) A pseudo-correlation gas for which a pseudo-correlation exists between itself and the THC concentration of the exhaust gas (referred to in the Claims as a component for which a pseudo-correlation exists between itself and the total analysis value of the predetermined plurality of components) such as inorganic gases (such as H₂O, CO₂, CO, NO, NO₂, N₂O, and NH₃ and the like) and the like.

The THC concentration of the second reference sample may be measured in advance using the FID analyzer 400. Alternatively, if the single component gas concentration is already known, then the THC concentration may be calculated based on the relevant gas concentration. Moreover, in a case in which the single component gas forming the second reference sample is theoretically not contributing to the THC concentration, then that THC concentration may be set to zero without being measured. In the present embodiment, the THC concentration of a ‘hydrocarbon gas’ that has sensitivity towards an FID analyzer is measured by the FID analyzer 400. In contrast, the THC concentration of an ‘FID-insensitive gas’ or a ‘pseudo-correlation gas’, which are gases that, theoretically, do not contribute towards the THC concentration, are set to zero without being measured by the FID analyzer 400.

In the same way as the first reference sample, the second reference sample is also introduced into the FTIR analyzer 100, and the light absorption spectral data thereof is acquired by the main analysis unit 51. The receiving portion 53 then receives the light absorption spectral data for the second reference sample, which is interim information calculated by the main analysis unit 51, and this light absorption spectral data is linked to the THC concentration of the second reference sample so as to create second reference sample data. This second reference sample data is then stored in the reference sample data storage portion D 1.

Furthermore, in this embodiment it is also possible to acquire peripheral situation data that includes at least the temperature and the pressure of the first reference sample and the second reference sample via sensors (not shown in the drawings) that are provided in the system and/or an input from an operator. The receiving portion 53 then acquires this peripheral situation data for the first reference sample and the second reference sample, and attaches the relevant data as subsidiary data to the relevant first reference sample data and second reference sample data, and then stores the data in the reference sample data storage portion D1.

The total analysis value calculating portion 52 calculates the THC concentration in the measurement sample (i.e., exhaust gas) from the light absorption spectral data of this measurement sample taking the plurality of reference sample data stored in the reference sample data storage portion D1 as training data and, more specifically, is provided with a correlation calculating portion 521 and a calculation main unit 522. Note that this THC corresponds to the plurality of components described in the Claims, and the THC concentration corresponds to the total analysis value described in the Claims.

Taking the plurality of first reference sample data stored in the reference sample data storage portion D1 as training data, the correlation calculating portion 52 performs machine learning on correlations between the light absorption spectral data and the THC concentrations that are in common with each other in the first reference sample data, and subsequently calculates a machine learning model.

Here, in order to calculate a more accurate machine learning model, the correlation calculating portion 521 also refers to the plurality of second reference sample data as training data.

More specifically, by taking the second reference sample data which contains the THC concentration and the light absorption spectral data of the hydrocarbon gas as training data, the correlation calculating portion 521 is able to learn the individual contributions of each hydrocarbon component to the light absorption spectral data of the first reference sample.

Moreover, by taking the second reference sample data which contains the THC concentration (=0) and the light absorption spectral data of the FID-insensitive gases as training data, the correlation calculating portion 521 is able to learn that components containing carbonyl carbon (in other words, components having no sensitivity when measured by an FID analyzer) do not contribute to the THC concentration.

Furthermore, by taking the second reference sample data which contains the THC concentration (=0) and the light absorption spectral data of the pseudo-correlation gases as training data, the correlation calculating portion 521 is able to learn that pseudo-correlation gases do not contribute to the THC concentration (in other words, avoids learning a pseudo-correlation).

The correlation data showing the machine learning model calculated by the correlation calculating portion 521 in this way is stored in a correlation data storage portion D2 that has been established in a predetermined area of the memory.

Note that, in this correlation calculating portion 521, because learning is repeated each time reference sample data is added, and the correlation is updated, the accuracy of the correlation is improved proportionately as the quantity of the respective reference sample data increases.

Moreover, the correlation calculating portion 521 of this embodiment is formed so as to calculate the correlations using the peripheral situation data for each reference sample also as a parameter, in other words, is formed in such a way that a correlation changes in accordance with the temperature and pressure and the like of each reference sample, however, it is also possible for the correlation calculating portion 521 to not refer to the peripheral situation data when calculating a correlation.

The calculation main unit 522 calculates the THC concentration of a measurement sample by matching a correlation calculated by the correlation calculating portion 521 to the spectral data for the measurement sample. At this time, because the peripheral situation data for the measurement sample has been acquired in the receiving portion 53, the calculation main unit 522 is able to use a correlation that corresponds to the peripheral situation data for the measurement sample when calculating the THC concentration.

Next, an operation of the exhaust gas measurement system 200 having the above-described structure will be described with reference to FIG. 4.

A learning operation will now be described. Firstly, the light absorption spectral data and THC concentration of the first reference sample are acquired (step S1). More specifically, an automobile is run on the chassis dynamo 300 and the exhaust gas thereof, which is serving as the first reference sample, is guided to the FID analyzer 400 and the FTIR analyzer 100. Note that it is not essential that an automobile be run on the chassis dynamo 300, and it is also possible for an engine that is connected to an engine dynamo to be run, or for drive system components such as a transmission and the like to be run on a drive system dynamo. Next, in the FID analyzer 400 the THC concentration is measured, while in the FTIR analyzer 100 the light absorption spectral data of this exhaust gas is measured by the main analysis unit 51. In this embodiment, the FID analyzer 400 and the FTIR analyzer 100 perform the exhaust gas measurement (i.e., analysis) in mutual synchronization at fixed timings (for example, from several msec ~ several sec). Each time a measurement is performed, the receiving portion 53 acquires the light absorption spectral data of the exhaust gas calculated by the main analysis unit 51 and the THC concentration of the exhaust gas analyzed by the FID analyzer 400, and sequentially stores these as first reference sample data in the reference sample data storage portion D1. At this time, the receiving portion 53 acquires the temperature and pressure of the exhaust gas, and attaches these as subsidiary data to the reference sample data, and then stores these in the reference sample data storage portion D1.

In this way, because the engine state of the automobile changes in a variety of ways in conjunction with the elapsed time since the engine started running or with changes in the engine revolution speed or the like, so that the state of the exhaust gas (i.e., the composition, pressure and temperature thereof) also sequentially changes so as to correspond to the changing state of the engine, a plurality of reference sample data in which at least the THC concentrations are mutually different from each other are obtained from the above-described sequential measurements.

Next, the light absorption spectral data and THC concentration of the single component gas which is serving as the second reference sample are acquired (step S2).

More specifically, firstly, the hydrocarbon gas (i.e., a single component), which is serving as the second reference sample, is guided from a gas cylinder or the like to the FID analyzer 400 and the FTIR analyzer 100. Next, in the same way as for the above-described reference sample 1, the THC concentration is measured in the FID analyzer 400, while the light absorption spectral data of hydrocarbon gas is measured in the FTIR analyzer 100. The THC concentrations and light absorption spectral data thus measured are then stored as second reference material data in the reference material data storage portion D1. Here, the plurality of mutually different types of hydrocarbon gases (i.e., methane, toluene, octane, and the like) are guided to the FID analyzer 400 and the FTIR analyzer in that sequence, and the THC concentrations and light absorption spectral data for each hydrocarbon gas are acquired and stored in sequence.

Next, the FID-insensitive gas (i.e., a single component gas) which is serving as the second reference sample is guided from the gas cylinder to the FTIR analyzer 100, and the light absorption spectral data of the FID-insensitive gas is measured by the FTIR analyzer 100. Here, the THC concentration (i.e., zero) of the FID-insensitive gas is input into the receiving portion 53 in advance by an operator. Each time the light absorption spectral data of the FID-insensitive gas is measured, the receiving portion 53 links it with previously input THC concentrations and stores it in the reference sample data storage portion D1 as second reference sample data. In the same way as the hydrocarbon gases, a plurality of mutually different types of FID-insensitive gases (i.e., formaldehyde, formic acid, and the like) are guided in sequence to the FTIR analyzer 100, and the THC concentrations and light absorption spectral data for each FID-insensitive gas are stored in sequence.

Next, the pseudo-correlation gas (i.e., a single component gas) which is serving as the second reference sample is guided from the gas cylinder to the FTIR analyzer 100 and, in the same way as the FID-insensitive gas, the measured light absorption spectral data and the previously input THC concentration (i.e., zero) thereof are linked together and then stored in the reference sample data storage portion D 1 as second reference sample data.

Next, the correlation calculating portion 521 refers to the large quantity of first reference sample data and second reference sample data that are stored in the reference sample data storage portion D1, and calculates a correlation between the light absorption spectral data and the THC concentration using machine learning (step S3). The correlation obtained as a result of this is then stored in the correlation data storage portion D2 (step S4).

At this point the learning is ended.

After the learning has ended in this manner, without using the FID analyzer 400, it is possible for the measurement of the actual THC concentration to be performed using only the FTIR analyzer 100. While performing this THC concentration measurement, another automobile test subject is placed on the chassis dynamo 300 and run, and the exhaust gas therefrom is guided to the FTIR analyzer 100.

In the FTIR analyzer 100, the main analysis unit 51 acquires the light absorption spectral data for the exhaust gas (step S5). Once this is done, the total analysis value calculating portion 52 (i.e., the calculation main unit 522) applies the correlation stored in the correlation data storage portion D2 to the light absorption spectral data, and then calculates the THC concentration (step S6).

In this way, according to the analysis device 100 that is formed in this manner, because it is possible to perform learning using, as training data, not only the measurement data for exhaust gas containing a plurality of hydrocarbon components (i.e., the first reference sample), but also the measurement data for single component gases such as hydrocarbon gases, FID-insensitive gases, and pseudo-correlation gases and the like (i.e., the second reference sample), it is possible to calculate a highly accurate machine learning model that has learned information about the level of contribution of each hydrocarbon element to the THC concentration, about components having no contribution to the THC concentration, and about components having a pseudo-correlation. By using this highly accurate machine learning model it becomes possible to estimate a THC concentration with a high level of accuracy from the spectral data for the measurement sample.

Here, a comparison between the accuracy of an analysis of a THC concentration performed using the analyzer 100 of an embodiment of the present invention (analysis device A) and the accuracy of an analysis of a THC concentration performed using a conventional analysis device (analysis device B) is shown in FIG. 5. Analysis device A calculates a THC concentration using a machine learning model that has performed learning using as training data the above-described exhaust gas (i.e., the first reference sample) and hydrocarbon gas, FID-insensitive gas, and pseudo-correlation gas (i.e., the second reference sample). In contrast, analysis device B calculates a THC concentration using a machine learning model that has performed learning using as training data only the exhaust gas (i.e., the first reference sample. Using these analysis devices the exhaust gas from a vehicle that was test run under a variety of conditions was analyzed, and the THC concentration thereof calculated. This exhaust gas was also analyzed using an FID analyzer, and the THC concentration thereof calculated. Errors (i.e., estimated errors) in the THC concentrations measured by each analysis device were then calculated. The results are shown in FIG. 5. FIG. 6 is a graph showing the state of the exhaust gas (i.e., the gas concentration/ THC ratio) in the area marked by a dotted line and the area marked by a double-dot chain line in FIG. 5.

As can be seen from FIG. 5, the estimated errors averaged approximately 10% in analysis device B which performed learning using only the exhaust gas as training data. In contrast, the estimated errors were 5% or less for all measurement subjects in analysis device A which performed learning using hydrocarbon gas, FID-insensitive gas, and pseudo-correlation gas in addition to the exhaust gas as training data. Accordingly, it can be seen that analysis device A had improved analysis accuracy. In particular, compared with conditions in which there was a low proportion of methane (i.e., the area marked by a dotted line in FIG. 5 and FIG. 6), in conditions in which there was a high proportion of methane (i.e., the area marked by a double-dot chain line in FIG. 5 and FIG. 6), the improvement in the analysis accuracy obtained by performing learning using the second reference sample (i.e., the hydrocarbon gas and the like) as training data was remarkable.

Note that the present invention is not limited to the above-described embodiment.

For example, as far as the THC light absorbance is concerned, because moisture and other interference components are contained in a measurement subject, it is also possible to calculate a THC concentration based on a corrected light absorbance spectrum from which the effects of such interference components have been reduced or removed. If this type of method is employed, then the analysis accuracy is improved even more.

Furthermore, it is also possible to form a learning device for analysis in which the functions of the individual component analysis portion 512 and the calculation main unit 522 have been omitted from the above-described analysis device and into which only a reference sample is introduced, and that only performs a correlation calculation. A correlation determined using this learning device for analysis can be used by other FTIR analyzers.

Moreover, when performing a correlation calculation, instead of limiting the parameters to values relating to the physical attributes of a sample such as the temperature and pressure and the like of the first reference sample and the second reference sample, it is also possible for other peripheral situation data to be used. Namely, other parameters may be added such as, for example, combustion information for the engine (i.e., information relating to supercharging, EGR, rich/stoichiometric/lean, laminar flow, uniform flow, direct injection, and port injection and the like), engine head configuration, ignition timing, composition of the catalyst, type of fuel, fuel oxygen content, inorganic gas component, soot concentration, SOF concentration, engine type, engine revolution speed, load information, hot start, cold start, oxygen concentration, catalyst temperature, gear ratio, and room temperature and the like. In addition, calculated correlations may be set for one or for each of a plurality of these parameters (for example, for each type of engine, or each type of combustion system, or each type of catalyst, or each type of fuel and the like). In other words, as the correlation data stored in the correlation data storage portion D2, the analysis device 100 may be provided with a plurality of types of correlation data categorized for one parameter or for each of a plurality of types of parameters.

Conversely to this, it is also possible to employ a structure in which either none of or only a portion of the peripheral situation data is used as a parameter for the correlation calculation, and instead only peripheral situation data having a strong effect on (i.e., that is highly relevant to) the THC concentration (i.e., the total analysis values) calculated and measured by the analysis device is extracted.

If this type of structure is employed, then because it is possible to ascertain peripheral situation data, in other words, design parameters that are highly relevant to the THC concentration, the present invention can be supplied as a design development support system to automobile manufacturers and catalyst manufacturers.

Depending on the peripheral situation data that is used in the correlation, there may be cases in which learning must be performed again for each new measurement such as, for example, cases in which the type of engine changes. In that respect, if it is possible to reduce the peripheral situation data that is added and to acquire a correlation between the spectral data and the THC concentration (i.e., the total analysis values), then the general versatility of the analysis device is improved. More specifically, an aspect in which not a single piece of peripheral situation data is added to the correlation calculation, or an aspect in which the physical state (for example, the pressure, temperature, refractive index, viscosity and the like) of the sample itself is added to the correlation calculation, but other external attributes (for example, the engine type, ignition timing and the like) are not added to the correlation calculation may be considered.

In a case in which, as one peripheral situation item, the temperature of the exhaust gas (i.e., the first reference sample) is set as a parameter when calculating a correlation, it is preferable that the exit temperature of the tail pipe of an automobile on the chassis dynamo 300 be measured using a sensor or the like, and that the measured temperature be set as a parameter.

The range of the spectral data used for learning and for analysis may be only a wave number range that includes the component subject to analysis, or may be broadened to a predetermined range that exceeds this. In addition, it is also possible to remove a wave number range of interference components.

More specifically, the range of the spectral data used for learning and for analysis may be set to not less than 2800 cm⁻¹ and not more than 3200 cm⁻¹.

If the range of the spectral data is set within the above-described range, then because this includes the wave number range of the HC that are serving as the component being analyzed, but excludes the wave number range of water (approximately 3400 cm⁻¹ or more), which is an interference component, the effect of water on the calculation of the THC concentration of the measurement sample can be reduced so that the measurement accuracy can be improved even further.

Prior to the calculation of a HC having a small molecular weight being performed, it is also possible for the concentrations of each HC to be determined by the main analysis unit 51, and for the total concentrations of one or a plurality of HC having a large molecular weight to be subtracted from the THC concentration.

Moreover, as another embodiment, it is also possible for a plurality of (for example, two or more) correlation data that have been calculated for each concentration segment of the THC concentrations to be stored in the correlation data storage portion D2. In this case, the correlation calculating portion 521 may divide the THC concentrations into a plurality of (for example, two or more) concentration segments, and correlations between the light absorption spectral data and the THC concentration may be calculated for each of these concentration segments and the resulting correlation data then stored in the correlation data storage portion D2. When the calculation main unit 522 receives the light absorption spectral data for a measurement sample, based on the surface area and the like of the relevant light absorption spectral data, it may select one correlation data item that matches the relevant light absorption spectral data from among the plurality of correlation data stored in the correlation data storage portion D2. The calculation main unit 522 may then apply this selected correlation data to the spectral data of the measurement sample, and calculate the THC concentration of the measurement sample.

Moreover, as yet another embodiment, it is also possible for a plurality of correlation data that have been calculated for each type of fuel (for example, gasoline, alcohol content, bio-based ether and the like) in the correlation data storage portion D2. In this case, in accordance with the fuel types that generate exhaust gas, which is serving as the measurement sample, the calculation main unit 522 may select the correlation data for the closest fuel type from among the plurality of correlation data stored in the correlation data storage portion D2, and using this selected correlation data may then calculate the THC concentration for the measurement sample. In this case, the calculation main unit 522 may be formed so as to identify the fuel type based on the concentration of each individual component calculated by the individual component analysis portion 512 and on the light absorption spectral data created by the spectral data creation portion 511.

Furthermore, in this case, it is also possible for the analysis device 100 to be additionally provided with a fuel type correlation data storage portion that stores fuel type correlation data obtained by calculating a correlation between the light absorption spectral data of a measurement sample and the fuel type using machine learning. In this case, when the calculation main unit 522 receives the light absorption spectral data for a measurement sample, it may then identify the fuel type by matching the correlation shown by the fuel type correlation data to the relevant light absorption spectral data. The calculation main unit 522 may then select the correlation data corresponding to the identified fuel type from the correlation data storage portion D2, and calculate the THC concentration.

The analysis device 100 of the above-described embodiments calculates a correlation between the spectral data of a reference sample and the THC concentration by itself, however, the present invention is not limited to this. It is also possible for an analysis device 100 of another embodiment to use a correlation calculated previously by another learning device for analysis that performs correlation calculations, and to calculate a THC concentration directly from the spectral data of a measurement sample based on this correlation.

More specifically, as is shown in FIG. 7, the analysis device 100 may be formed in such a way that the arithmetic processing device 5 does not function as the reference sample data storage portion D1 or the correlation calculating portion 521. Here, it is also possible for the receiving portion 53 to receive via a network or the like correlation data that shows a correlation that has already been calculated by another learning device for analysis (i.e., learned data), and for this data to be stored in advance in the correlation data storage portion D2. In addition, it is also possible for the calculation main unit 522 to calculate the THC concentration of a measurement sample by matching correlation data already stored in the correlation data storage portion D2 to the light absorption spectral data of the measurement sample.

Note that it is also possible for the receiving portion 53 to receive new correlation data from another learning device for analysis at regular predetermined timings, and to regularly update the correlation data stored in the correlation data storage portion D2.

In the above-described embodiments, a hydrocarbon gas, an FID-insensitive gas, and a pseudo-correlation gas are all used for the second reference sample, however, the present invention is not limited to this. As another embodiment it is possible for only a portion of these to be used as the second reference sample, or for single component gases other than these to be used. Furthermore, the second reference sample is not limited to being a gas and may instead be a liquid.

Moreover, in the above-described embodiments, the hydrocarbon gas, FID-insensitive gas, and pseudo-correlation gas used for the second reference sample are consisting of single component gases, however, the present invention is not limited to this. As another embodiment, if the second reference sample is different from the first reference sample and the THC content thereof is already known, then it is possible for the second reference sample to be consisting of multiple component gases.

Furthermore, in another embodiment, it is also possible to use a fuel (in either a liquid or gaseous state) that is a combustion source that generates exhaust gas which is serving as a measurement sample as the second reference sample.

In the above-described embodiments the first reference sample and the measurement sample are exhaust gases, however, they may also be atmospheric air or another gas, or may also be a liquid.

Moreover, it is not necessary that the first reference sample and the measurement sample be of the same type, and it is also possible, for example, to use a standard gas or the like that is created by mixing a plurality of components that are to be subject to analysis into a main component such as nitrogen or the like. In this case, because the total analysis values of the plurality of components are already known, it is not necessary to use another analysis device in order to analyze the plurality of reference sample components.

Furthermore, the components that are to be subject to analysis are not limited to hydrocarbons (HC), and may be other components such as non-methane hydrocarbons (NMHC), non-methane non-ethane hydrocarbons (NMNEHC), petroleum hydrocarbons in the soil (PH), volatile organic compounds in the atmosphere (VOC), the calorific potential of petroleum-based fuels, nitrogen oxides, and the like.

The analysis device of the present invention may be applied to analysis devices that measure a plurality of components, and measure the components when they are added together. For example, the present invention may be applied to analysis devices that irradiate light onto a measurement sample and then perform analysis from the resulting spectrum, analysis devices that perform analysis using a mass spectrum obtained by performing ionization on a measurement sample, and also to NDIR and mass spectrometers. In addition, the present invention may be applied, for example, to scattering particle size distribution analyzers other than emission spectrophotometers. Moreover, the present invention is not limited to analyzing exhaust gas from automobiles and is also capable of analyzing exhaust gas from internal combustion engines such as those used in shipping vessels, aircraft engines, agricultural machinery, and industrial machinery and the like.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

### INDUSTRIAL APPLICABILITY

According to the present invention, it is possible to improve measurement accuracy in an analysis device such as an FTIR analyzer and the like.

What is claimed is:

1. An analysis device that analyzes a measurement sample based on spectral data obtained from that measurement sample, comprising:
a correlation data storage portion that stores correlation data that shows a correlation between spectral data for a reference sample in which total analysis values for a predetermined plurality of components are already known, and a total analysis value of the reference sample; and
a calculation main unit that applies the correlation data stored in the correlation data storage portion to the spectral data obtained from the measurement sample, and then calculates the total analysis values of the predetermined plurality of components contained in the measurement sample, wherein
the reference sample contains a first reference sample that contains the predetermined plurality of components, and a second reference sample that is consisting of either one or a plurality of the components that are part of the first reference sample, and wherein
the correlation data shows a machine learning model in which calculated as the training data are:
first reference sample data that includes spectral data for the first reference sample and a total analysis value for the first reference sample; and
second reference sample data that includes spectral data for the second reference sample and a total analysis value for the second reference sample.

2. The analysis device according to claim 1, wherein the second reference sample is either one or a plurality of the components that make up the predetermined plurality of components.

3. The analysis device according to claim 1, wherein the second reference sample is consisting of either one or a plurality of the components that do not contribute to the total analysis value, among the reference sample in which total analysis values for the predetermined plurality of components are already known.

4. The analysis device according to claim 1, wherein the second reference sample is consisting of either one or a plurality of the components for which a pseudo-correlation exists between itself and the total analysis value.

5. The analysis device according to claim 1, wherein the second reference sample is a fuel that generates exhaust gas.

6. The analysis device according to claim 1, wherein the measurement sample or the first reference sample is exhaust gas, and the predetermined plurality of components are hydrocarbons.

7. The analysis device according to claim 6, wherein the total analysis value of the predetermined plurality of components is the concentration of the total hydrocarbons contained in the exhaust gas.

8. The analysis device according to claim 1, wherein the analysis device is an FTIR-type device.

9. The analysis device according to claim 1, wherein the total analysis value of the first reference sample and the total analysis value of the second reference sample are obtained via measurements performed by an FID analyzer.

10. The analysis device according to claim 1, wherein a plurality of correlation data calculated for each one of various types of fuel is stored in the correlation data storage portion, and
the calculation main unit switches the correlation data that is to be applied to the spectral data obtained from the measurement sample in accordance with the type of fuel used to generate the measurement sample.

11. A method of analyzing a measurement sample based on spectral data obtained from that measurement sample, in which:
correlation data that shows a correlation between spectral data for a reference sample in which total analysis values for a predetermined plurality of components are already known, and a total analysis value of the reference sample is stored; and
the stored correlation data is applied to the spectral data obtained from the measurement sample, and the total analysis values of the predetermined plurality of components contained in the measurement sample are then calculated, wherein
the reference sample includes a first reference sample that contains the predetermined plurality of components, and a second reference sample that is consisting of either one or a plurality of the components that are part of the first reference sample, and wherein
the correlation data shows a machine learning model in which calculated as the training data are:
first reference sample data that includes spectral data for the first reference sample and a total analysis value for the predetermined plurality of components contained in the first reference sample; and
second reference sample data that includes spectral data for the second reference sample and a total analysis value for the predetermined plurality of components contained in the second reference sample.

12. A program for an analysis device that is installed in an analysis device that analyzes a measurement sample based on spectral data obtained from that measurement sample, and that causes the analysis device to perform:
functions of a correlation data storage portion that stores correlation data that shows a correlation between spectral data for a reference sample in which total analysis values for a predetermined plurality of components are already known, and a total analysis value of the reference sample; and
functions of a calculation main unit that applies the correlation data stored in the correlation data storage portion to the spectral data obtained from the measurement sample, and then calculates the total analysis values of the predetermined plurality of components contained in the measurement sample, wherein
the reference sample contains a first reference sample that contains the predetermined plurality of components, and a second reference sample that is consisting of either one or a plurality of the components that are part of the first reference sample, and wherein
the correlation data shows a machine learning model in which calculated as the training data are:
first reference sample data that includes spectral data for the first reference sample and a total analysis value for the first reference sample; and
second reference sample data that includes spectral data for the second reference sample and a total analysis value for the second reference sample.

13. A learning device for analysis comprising:
a receiving portion that receives spectral data obtained from a reference sample in which total analysis values for a predetermined plurality of components are already known;
a reference sample data storage portion that stores reference sample data that includes total analysis values for a plurality of the reference samples that are mutually different from each other; and
a correlation calculating portion that, taking the reference sample data as training data, employs machine learning to calculate a common correlation between the spectral data of each reference sample and the total analysis values, wherein
the reference sample includes a first reference sample that contains the predetermined plurality of components, and a second reference sample that is consisting of either one or a plurality of the components that are part of the first reference sample, and wherein
the reference sample data includes:
first reference sample data that contains spectral data for the first reference sample and a total analysis value for the predetermined plurality of components contained in the first reference sample; and
second reference sample data that contains spectral data for the second reference sample and a total analysis value for the predetermined plurality of components contained in the second reference sample.

14. A learning method for analysis comprising:
receiving spectral data obtained from a reference sample in which total analysis values for a predetermined plurality of components are already known;
storing reference sample data that includes total analysis values for a plurality of the reference samples that are mutually different from each other; and
employing machine learning to calculate a common correlation between the spectral data of each reference sample and the total analysis values, taking the reference sample data as training data, wherein
the reference sample includes a first reference sample that contains the predetermined plurality of components, and a second reference sample that is consisting of either one or a plurality of the components that are part of the first reference sample, and wherein
the reference sample data includes:
first reference sample data that contains spectral data for the first reference sample and a total analysis value for the predetermined plurality of components contained in the first reference sample; and
second reference sample data that contains spectral data for the second reference sample and a total analysis value for the predetermined plurality of components contained in the second reference sample.

15. A program for a learning device for analysis that causes the learning device for analysis to perform:
functions of a receiving portion that receives spectral data obtained from a reference sample in which total analysis values for a predetermined plurality of components are already known;
functions of a reference sample data storage portion that stores reference sample data that includes total analysis values for a plurality of the reference samples that are mutually different from each other; and
functions of a correlation calculating portion that, taking the reference sample data as training data, employs machine learning to calculate a common correlation between the spectral data of each reference sample and the total analysis values, wherein
the reference sample includes a first reference sample that contains the predetermined plurality of components, and a second reference sample that is consisting of either one or a plurality of the components that are part of the first reference sample, and wherein
the reference sample data includes:
first reference sample data that contains spectral data for the first reference sample and a total analysis value for the predetermined plurality of components contained in the first reference sample; and
second reference sample data that contains spectral data for the second reference sample and a total analysis value for the predetermined plurality of components contained in the second reference sample.
